(19) United States
(12) Patent Application Publication
(10) Pub. No.: US 2005/0058587 A1
(43) Pub. Date: Mar. 17, 2005

(54) Heterogeneous catalyst consisting of an aggregate of metal-coated nanoparticles

(76) Inventor: Alain Wagner, Strasbourg (FR)

Correspondence Address: YOUNG & THOMPSON, 745 SOUTH 23RD STREET, 2ND FLOOR, ARLINGTON, VA, 22202, US

(21) Appl. No.: 10/495,872

(22) PCT Filed: Nov. 19, 2002
(86) PCT No.: PCT/FR02/03955

(30) Foreign Application Priority Data
Nov. 20, 2001 (FR) 01/15013

(51) Int. Cl. C01B 33/12

(52) U.S. Cl. 423/335; 423/625; 423/608

(57) ABSTRACT

The invention concerns mainly an aggregate of nanoparticles based on at least an inorganic material, functionalized at the surface with at least a metallic derivative, said functionalized nanoparticles being organized in said aggregate so as to form a three-dimensional porous structure comprising channels. The invention also concerns the use of said aggregate as heterogeneous catalyst.

The present invention relates to the field of heterogeneous catalysis and is targeted more specifically at providing a novel family of heterogeneous catalysts which, due to their porous three-dimensional structure, prove to be advantageous in terms of catalytic activity. It also provides a process of use in giving rapid access to a wide variety of metal catalysts.

There are currently three main types of heterogeneous catalysts, namely dispersed metals, metal oxides and “impregnated” metals. As regards more particularly the third category of heterogeneous catalysts, namely that associated with a support material, several methods of preparation have already been proposed. Mention may first of all be made, by way of representation of these methods, of that which involves the deposition of the metal or of the metal alloy at the surface of an inorganic macrogel substrate. A second method of preparation uses a block copolymer, such as polystyrene-poly(acrylic acid) copolymers, as support material. The metal is adsorbed inside and at the surface of the corresponding colloidal particles. However, all these catalysts exhibit certain limitations in terms of reactivity and/or selectivity.

The present invention is targeted in particular at providing a novel family of heterogeneous catalysts which makes it possible to overcome the abovementioned disadvantages.

More specifically, a subject-matter of the present invention is an aggregate of nanoparticles based on at least one inorganic material which are functionalized at their surface by at least one metal derivative, these functionalized nanoparticles being organized in the said aggregate so as to form a three-dimensional porous structure comprising channels. The nanoparticles can be functionalized by the same metal derivative or by different derivatives.

The inventors have unexpectedly demonstrated that it is possible to prepare such aggregates of nanoparticles having a particularly advantageous catalytic activity by mixing corresponding metallized nanoparticles under specific conditions.

The aggregates of the invention have a three-dimensional structure in which the nanoparticles are organized. The organization of these nanoparticles with respect to one another leads to the formation of channels, thus conferring a porous nature on the said aggregate. This porosity is particularly advantageous in terms of catalytic activity in so far as it favours accessibility to a very large number of catalytic sites.

An aggregate of particles according to the invention advantageously exhibits a porosity at least equal to 30 m²/g, preferably of between 50 and 150 m²/g and more preferably of the order of 85 m²/g.

An aggregate according to the invention is also characterized by a large active metal surface area generally similar to its overall surface area. Thus, most frequently, the nanoparticles are homogeneously functionalized over their entire specific surface area.

As regards more specifically the nanoparticles, they are composed of at least one inorganic material. As this material has to be subjected to a calcination stage during the process for the preparation of the said aggregate for which it is intended, it is important that it be compatible with heating at high temperature, that is to say greater than 200° C. Mention may more particularly be made, by way of representation of the materials which are suitable according to the invention, of silica, alumina, zirconium oxide or analogues and their mixtures. The preparation of nanoparticles from materials of this type is already well documented and therefore raises no difficulty for a person skilled in the art. Generally, the nanoparticles are dried on conclusion of their preparation process by heating under vacuum.

The nanoparticles considered in the context of the present invention are preferably nonporous. They are distinguished as such from larger particles, which are microporous and mesoporous. Due to this specific feature, they guarantee that the metal catalytic sites will be located essentially on their external surface.

They are preferably monodisperse, so as to provide structural homogeneity and overall homogeneity in terms of catalytic activity.

Their specific surface area (in the dry form) is generally between 50 and 150 m²/g and preferably is of the order of 95 m²/g.

As regards more particularly the size of these nanoparticles, it is adjusted so as to optimize the stability of the aggregate which they are intended to compose. Preferably, this size is greater than 10 nm and less than 100 nm. As it happens, there is a risk that an excessively large size, that is to say greater than 100 nm, would lead to low stability of the aggregates. Furthermore, there is a risk that these nanoparticles would exhibit an intrinsic porosity.

The nanoparticles employed in the context of the present invention are functionalized at the surface with at least one metal complex. The latter, being attached at the surface, favour maximum accessibility to the resulting metal sites. Furthermore, this complex has to be strongly attached, so as to avoid any problem of escape of the metal (leaching) which might lead to a loss in catalytic activity. As it happens, these metal complexes are not adsorbed at the surface of the nanoparticles but are chemically bonded to the material constituting them by condensation with reactive functional groups present at the surface of the material. In the specific case of materials of silica and alumina type, these functional groups are essentially hydroxyl functional groups. The ligands present on the metals which generally make possible such a condensation are either halogen atoms, preferably chlorine atoms, or alkoxide groups. It is also possible to envisage covalently bonding these metal complexes to the material via a specific coupling agent. The latter can consist of a compound, one of the ends of which is capable of reacting with the functional group present on the inorganic material and the other end of which is capable of reacting with one of the ligands of the metal complex which it is desired to attach.

Mention may more particularly be made, by way of representation of the metals capable of being attached in the form of complexes to the support material constituting the nanoparticles, of the metals belonging to groups IB, IIB, IIIB, IIIA, IVB, VB, VIB, VIIB and VIII of the Periodic Table. Mention may more particularly be made, by way of illustration of these metals, of chromium, boron, titanium, silver, aluminium, nickel, rhodium, cobalt, molybdenum, copper and palladium.

These metals can be grafted to the surface of the nanoparticles in the form of their halogenated, hydroxylated, alkoxylated or complexed derivatives. The complexed derivatives include in particular metal complexes chelated by ligands of cyclopentadienyl type.

Mention may more particularly be made, by way of representation of these metal complexes, of the following complexes:
Co(NH₃)₂Cl₂
Mo(CO)₆
TiCp₂Cl₂
Co(Acac)₂
Cu(Acac)₂
Ni(PPh₃)₂Cl₂; Ni(Cod)₂
Pd(Cod)₂Cl₂; Pd(OAc)₂
[RhClCod]₂; [RhCpCl]₂
Cr[η₆-PhOMe] (CO)₃
   in which Acac, Cod and Cp respectively symbolize acetylacetonate, cyclooctadienyl and cyclopentadienyl groups.

The claimed aggregates can comprise one, two or a greater number of different nanoparticles, that is to say nanoparticles respectively functionalized by different metal complexes. These “different” metal complexes can be distinct in the nature of their respective metals and/or the nature of the ligands combined with the metal under consideration. In other words, two metal complexes possessing the same metal but combined with different ligands will be regarded as different within the meaning of the invention.

The distinct nanoparticles can be combined in different or equivalent amounts.

Mention may more particularly be made, by way of illustration of aggregates in accordance with the present invention, of those combining the following pairs of metal complexes: Ni(PPh₃)₂Cl₂/[RhClCod]₂; Ni(PPh₃)₂Cl₂/Ni(Cod)₂; Ni(PPh₃)₂Cl₂/Pd(OAc)₂; Ni(PPh₃)₂Cl₂/[Rh(Cp)Cl]₂; Ni(Cod)₂/[Rh(Cp)Cl]₂; Pd(OAc)₂/Ni(Cod)₂ and Pd(OAc)₂/[Rh(Cp)Cl]₂.

Mention may more particularly be made, by way of illustration of aggregates comprising a single type of nanoparticle, of those respectively comprising, as metal complex, Pd(OAc)₂ and [Rh(Cp)Cl]₂.

For all the aggregates identified above, the metal complexes are preferably present on silica nanoparticles.

The present invention is also targeted at the use of the aggregates in accordance with the present invention as heterogeneous catalyst in organic synthesis reactions.

These organic synthesis reactions can, for example, be reactions of oxidation, reduction or coupling type, acid/base reactions, and the like.

The claimed aggregate is preferably used therein in a proportion of 0.1% to 2% by weight and preferably 1%, with respect to the weight of the substrate to be converted.

Another subject-matter of the present invention is a heterogeneous catalyst for organic synthesis comprising at least one aggregate in accordance with the present invention.

Another subject-matter of the present invention is a process for the preparation of the said aggregate.

As it happens, this process comprises:
(A) the suspension, in an anhydrous organic solvent, of nanoparticles functionalized at the surface by identical or different metal complexes,
(B) the addition of an aggregating agent to the said suspension in an amount sufficient to lead to the formation of a colloidal solid; and
(C) the recovery of the said aggregate.

As regards the first stage (A), the solvent is chosen so as to make it possible to suspend the nanoparticles. It is generally an organic solvent, such as THF, CH₃CN, toluene and CH₂Cl₂, more preferably it is toluene. By way of indication, the nanoparticles are dispersed in toluene in a proportion of 1 to 20 mg/ml and preferably 10 mg/ml.

The aggregating agent is added to this suspension with stirring. The aggregating agent is chosen so that it can be adsorbed at the surface of the particles. Interaction of the particles with one another ensues, which results in the formation of the expected aggregates. Water, aqueous/alcoholic solvents and solutions of ammonium salts are suitable in particular as such. The amount of aggregating agent added is adjusted until the expected colloidal solid is obtained.

As regards the aggregate, it is recovered by conventional techniques, i.e. by filtering the reaction mixture and/or centrifuging the reaction mixture or by simple evaporation.

According to a preferred alternative form of the invention, the aggregate is subjected to a calcination operation at a temperature compatible with the three-dimensional structure.

In view of its simplicity of implementation, the claimed process is particularly useful for preparing a wide variety of catalysts by simple combination of various types of nanoparticles. As such, it is particularly advantageous for a combinatorial approach for the purpose of the development and/or characterization of novel heterogeneous catalysts.

As regards more particularly the functionalization of the nanoparticles, it is carried out by bringing together the nanoparticles and the metal complex under consideration under operating conditions, namely heating and stirring, compatible with their reactivity. Example 2 below reports a protocol for the functionalization of the nanoparticles.

The examples which appear below are intended to illustrate the invention and have no limiting nature with respect to the latter.

### EXAMPLE 1

### Preparation of Graded Silica Nanoparticles

A mixture of ultrapure water (2 620 g, 145.55 mol), of 95% ethanol (3 121 g) and of a 20% aqueous ammonia solution (726 g, 8.57 mol of NH₃) in a 10 l three-necked flask is brought to 60° C. with vigorous mechanical stirring. Tetraethoxysilane (1 560 g, 7.5 mol) is added dropwise using a peristaltic pump at a rate of 14 ml/min while maintaining the stirring of the mixture at 300 rev/min. After the end of the addition, the mixture is stirred for 3 hours and is allowed to fall to ambient temperature. The ammonia, the possible residues of the unreacted tetraethoxysilane and the ethanol present are distilled off from the crude reaction mixture. Ultrapure water is gradually added, so that the distillation is always carried out at constant volume. A suspension of nanoparticles in water is obtained. Prior to their use, these particles have to be dried. To do this, the water is first of all removed by carrying out an azeotropic distillation of the suspension using toluene. The particles thus obtained are subsequently dried under vacuum at 200° C. for twelve hours.

### EXAMPLE 2

### Functionalization of the Nanoparticles by Metal Complexes

General procedure

The anhydrous nanoparticles, stored under an argon atmosphere, are quickly transferred into and weighed in flame-treated dry glassware under vacuum and then purged with argon. The assembly is again placed under vacuum, flame-treated with a heat stripper and purged with argon before addition of the solvent. The amounts functionalized vary from 1 to 32 g. For 1 g of silica, placed in a 250 ml two-necked flask equipped with a reflux condenser, 100 ml of solvent are added to the nanoparticles, which are suspended via an ultrasonic bath. The metal complex under consideration, diluted beforehand in 25 ml of the same solvent, is added dropwise to the mixture in a proportion of 3×10⁻⁴ mol/g of silica. After subjecting to ultrasound for approximately 30 minutes, the assembly is brought to reflux for 12 hours and stirred mechanically with a magnetic bar. At the end of the reaction, the mixture is rapidly transferred into 50 ml centrifuge tubes which are sealed with a Teflon tape secured with parafilm and are centrifuged at 4° C. at 4 800 rev/min, 3 838 G, for 2 minutes. The supernatant is removed. The particles are resuspended in the same amount of dry solvent, subjected to ultrasound and then centrifuged. The pellet is resuspended in the solvent used for the combinations of metallized nanoparticles and the corresponding formation of aggregates.

The solvent employed and the metal complexes used for the functionalization are detailed in Table 1 below for the nanoparticles synthesized by this procedure.

TABLE 1

| Grafted metal complex | Solvent |
|---|---|
| Co(NH₃)₂Cl₂ | 50% toluene/ |
| | 25% CH₃CN/25% THF |
| Mo(CO)₆ | 50% toluene/ |
| | 25% CH₃CN/25% THF |
| TiCp₂Cl₂ | 50% toluene/ |
| | 25% CH₃CN/25% THF |
| Co(Acac)₂ | 50% toluene/ |
| | 25% CH₃CN/25% THF |
| Cu(Acac)₂ | 50% toluene/ |
| | 25% CH₃CN/25% THF |
| Ni(PPh₃)₂Cl₂ | 50% toluene/20% CH₂Cl₂/ |
| | 30% THF |
| Pd(Cod)₂Cl₂ | 50% toluene/20% CH₂Cl₂/ |
| | 30% THF |
| [Rh(Cod)Cl]₂ | 50% toluene/20% CH₂Cl₂/ |
| | 30% THF |
| Cr[η₆-PhOMe](CO)₃ | 50% toluene/20% CH₂Cl₂/ |
| | 30% THF |

### EXAMPLE 3

### Preparation of Aggregates in Accordance with the Invention

General procedure

Suspensions obtained according Example 2 are combined. To do this, mixing is carried out in an equivolume fashion of the sols of particles functionalized according to the procedure described in Example 2. Water is added to the resulting mixture until the formation of the expected aggregate is observed. This aggregate is isolated from the reaction mixture by evaporation of the solvent.

The particles used are functionalized by the following complexes:
A: Ni(PPh₃)₂Cl₂
B: Pd(OAc)₂
C: Ni(Cod)₂
D: [Rh(Cp)Cl]₂

The following aggregates were obtained by mixing the particles identified above.
1: Aggregate+AA
2: Aggregate+AB
3: Aggregate+AC
4: Aggregate+AD
5: Aggregate+BB
6: Aggregate+BC
7: Aggregate+BD
8: Aggregate+CC
9: Aggregate+CD
10: Aggregate+DD

Each catalyst series thus obtained is treated at 200° C. overnight.

### EXAMPLE 4

### Characterization of the Catalytic Activity of Aggregates in Accordance with the Invention

One of the reactions tested is hydrosilylation, which leads to the predominant formation of the product substituted in the end position (I₁). During these tests, certain catalysts proved to be highly active in the isomerization of the double bonds, leading to I₂.

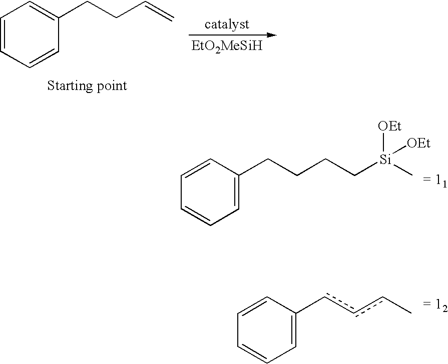

Pure 4-phenylbut-1-ene (375 μl; 330 mg; 1 eq.) is added to the catalyst (2.5 mg) placed beforehand in the reactor. Methyldiethoxysilane (400 μl; 335 mg; 5 mmol; 1 eq.) is then added. The mixture is brought to 85° C. with stirring for 16 hours.

The results are presented in Table 2 below:

TABLE 2

| | Hydrosilylation | Isomerization |
|---|---|---|
| Catalyst | (I₁ formed) | (I₂ formed) |
| PtO₂ | 90% | 0% |
| AA | 1% | 0% |
| AB | 0% | 74% |
| AC | 0% | 0% |
| AD | 51% | 5% |
| BB | 0% | 68% |
| BC | 0% | 65% |
| BD | 1% | 79% |
| CC | 0% | 2% |
| CD | 65% | 5% |
| DD | 60% | 5% |

1-17. (cancelled)

18. An aggregate of nanoparticles based on at least one inorganic material which are functionalized at their surface by at least one metal derivative, the said functionalized nanoparticles being organised in the said aggregate so as to form a three-dimensional porous structure comprising channels.

19. The aggregate of claim 18, which further exhibits a porosity at least equal to 50 m²/g.

20. The aggregate of claim 18, which further exhibits a metal surface area similar to its overall surface area.

21. The aggregate of claim 18, wherein the nanoparticles have a size of greater than 10 nm.

22. The aggregate of claim 18, wherein the nanoparticles have a size of less than 100 nm.

23. The aggregate of claim 18, wherein the inorganic material composing the said particles is or derives from silica, alumina, zirconium oxide, their mixtures or analogues.

24. The aggregate of claim 18, wherein the functionalization of the said nanoparticles consists of a covalent grafting of at least one metal derivative to at least one of the organic functional groups present at the surface of the said inorganic material.

25. The aggregate of claim 24, wherein the nanoparticles are functionalized homogeneously over the whole of their specific surface area.

26. The aggregate of claim 18, wherein the metals present at the surface of the said nanoparticles are selected from groups IB, IIB, IIIA and IIIB, IVB, VB, VIB, VIIB and VIII of the Periodic Table.

27. The aggregate of claim 18, wherein the metals present at the surface of the said nanoparticles are selected from chromium, boron, titanium, silver, aluminium, nickel, rhodium, cobalt, molybdenum, copper and palladium.

28. The aggregate of claim 18, which combines two or more types of nanoparticles respectively functionalized by different metal complexes.

29. The aggregate of claim 18, which combines the following metal complexes: Ni(PPh₃)₂Cl₂/[RhClCod]₂; Ni(PPh₃)₂Cl₂/Ni(Cod)₂; Ni(PPh₃)₂Cl₂/Pd(OAc)₂; Ni(PPh₃)₂Cl₂/[Rh(Cp)Cl]₂; Ni(Cod)₂/[Rh(Cp)Cl]₂; Pd(OAc)₂/Ni(Cod)₂; Pd(OAc)₂/[Rh(Cp)Cl]₂.

30. The aggregate of claim 18, which comprises silica nanoparticles functionalized by Pd(OAc)₃ or [Rh(Cp)Cl]₂.

31. A Process for the preparation of the aggregate of claim 18, which comprises the steps consisting in:
suspending nanoparticles functionalized at their surface by a metal complex in an anhydrous organic solvent;
adding an aggregating agent to the said suspension in an amount sufficient to lead to the formation of a colloidal solid, and
recovering the said aggregate.

32. The process of claim 31, wherein each type of nanoparticle is obtained beforehand by bringing together nanoparticles of an inorganic material and the organometallic complex under consideration in an anhydrous organic solvent.

33. A method making use of the aggregate of claim 18 as a catalyst in an organic chemistry reaction.

34. A heterogeneous catalyst, which comprises at least one aggregate according to claim 18.
